(19) United States
(12) Patent Application Publication
(10) Pub. No.: US 2010/0080523 A1
(43) Pub. Date: Apr. 1, 2010

(54) DOPED OPTICAL FIBRE WITH BROKEN SPACE SYMMETRY

(76) Inventors: Christelle Lesvigne, Limoges (FR); Vincent Couderc, Verneuil-Sur-Vienne (FR); Philippe Leproux, Limoges (FR); Jean-Louis Auguste, Limoges (FR); Guillaume Huss, Limoges (FR)

Correspondence Address: ARENT FOX LLP, 1050 CONNECTICUT AVENUE, N.W., SUITE 400, WASHINGTON, DC, 20036, US

(21) Appl. No.: 12/518,934

(22) PCT Filed: Dec. 12, 2007
(86) PCT No.: PCT/FR2007/002054

§ 371 Date: Sep. 15, 2009

(30) Foreign Application Priority Data
Dec. 12, 2006 (FR) 0610837

(51) Int. Cl. G02B 6/02; G02B 6/10; G02B 6/032

(52) U.S. Cl. 385/123; 385/142; 264/1.24

(57) ABSTRACT

The invention relates to a micro-structured optical fibre (1) including at least one core (7, 7A, 7B, 7C, 7D1 7E, 7F) with a core space symmetry, characterised in that said core contains at least one doping material distributed in said core according to a dissymmetrical implantation relative to said at least one symmetry axis.

The invention relates to a micro-structured optical fiber including at least one core having a shape space symmetry including at least one symmetry axis.

The optical fibers are known and used as waveguides. The micro-structured fibers include, in cross-section, a matrix of microscopic air channels. These air channels extend along the whole length of the optical fiber. In the centre of the optical fiber, one or several air channel(s) is/are non existing so as to form a zone having a higher index constituting a light trap and thus a core for the optical fiber. The core of a micro-structured optical fiber is thus the propagation place inducing a minimum light lost. A fiber may have a plurality of cores.

The non-linearity of an optical fiber only depends on the material it is made of. However, the threshold of existence of these effects depends on the power density propagating in the core and thus the confinement of power along the propagation thereof. Moreover, all the parametric effects on which complex spectral broadenings are based require a tuning of the phase velocities of the considered waves and are thus sensitive to the polarization effects and thus to the birefringence of the considered guide. As a matter of fact, even though a fiber is manufactured to be theoretically isotropic, the presence of impurities and physical constraints in the fiber imparts a so-called local or shaped birefringence therein. It is also known that the appearance of a birefringence in an optical fiber modifies the dispersion curve thereof, and makes the field propagation polarization-sensitive. Thus, the conditions of propagation in a non linear regime of the waves in the core of the guide are significantly affected by the presence of the local or shaped birefringence.

The publication “Highly birefringent photonic crystal fibers” by Ortigosa-Blanch and al., Optics letter, Vol. 25, 2000, discloses, for example, a micro-structured optical fiber, the core of which is formed within holes forming two symmetry axes. The core thus formed is thus substantially elliptic. This is shown by the appearance of a shape birefringence linked to the geometry of the fiber core. Such a birefringence is independent of a power of the wave propagating in the core. This birefringence is thus permanent and is a linear effect.

Other micro-structured fibers are known from the documents US-2005/105867 and US-2006/088262.

However, the elliptic core of the fiber described in the above-mentioned article has a birefringence induced in the geometric dissymmetry of the guide and may not exceed index variations of the order of approximately 3.10⁻³ to 7.10⁻³.

A system allowing the adjustment of the birefringence thanks to a dissymmetrical amplification in the fiber is also known from the document US-2004/086213. This control of birefringence is allowed thanks to the introduction of an active ion doping zone in the core of a standard fiber and thanks to the coupling of a second high power pump wave in order to induce a modification of the index in this doped zone through a non linear effect and thus to act on the birefringence parameters. In this system, the birefringence is called a “non linear” birefringence, since it is not permanent, it depends on the power of the incident wave and exists only when an auxiliary pumping is carried out in order to locally amplify the signal. Such a system has the drawback of requesting an external pump and of not supplying an improved birefringence in a static utilization (without a pump).

The problem that the invention also intends to solve is to further increase the effects of a linear birefringence in a micro-structured optical fiber.

This problem is solved according to the invention using a fiber as described hereabove, wherein said core includes at least one doping material distributed in said core according to a dissymmetrical implementation relative to said at least one symmetry axis.

According to the invention, the distribution of the doping material modifies the space symmetry of the core, which causes an improved anisotropy of the doped core of the fiber, with respect to a non doped core. Thus, the linear birefringence of the thus obtained optical fiber is modified, permanent and potentially improved.

The introduction of a space dissymmetry of transverse modes propagating in the core can be carried out through the introduction of a doping which directly modifies the index of a part of the core. This dissymmetry of the mode then induces an equivalent birefringence which makes the propagation polarization-sensitive.

The introduction of dissymmetry according to the invention also has the advantage of allowing the shifting of the dispersion zero of the modes propagating in the core towards lower wavelengths.

The introduction of a doping material in the core of a micro-structured optical fiber is known per se and makes it possible to amplify an optical signal propagating in the core of the fiber or to increase the non linear effects. Various doping materials have been proposed as a function of the signal to be amplified and the desired optical effect. In the known optical fibers, the doping materials are positioned at the centre of the core and symmetrically relative to symmetry axis of the core.

On the contrary, according to the invention, the doping material is distributed so as to break the symmetry of the core of the fiber.

Because of the dissymmetrical implantation of a doping material in the core of the fiber, the shape birefringence is reinforced by a birefringence induced by the geometry of the doping material. An increase in the index of the core in a given area, in a dissymmetrical way, enables an additional asymmetry of the mode profile and thus a modification of the birefringence. Phase tunings, which would not be accessible without this particular doping, are then possible.

For example, a core initially having a centro-symetrical profile, thus having an infinity of symmetry axis intersecting in the centre thereof, can be modified through the introduction of a non homogeneous doping on the whole surface of the core. Only one doped zone positioned on the edge of the core also makes it possible to break the centro-symetry of the core.

According to the invention, at least one doping material is positioned in a plurality of doping zones of said core, each of the doping zones being distinct, said doping zone being so arranged as to break said space symmetry.

Thus, the non isotropic distribution of the doping material or materials makes it possible to break the symmetry of the core and thus to increase the birefringence effect.

According to one embodiment, said core includes only one doping material, said doping material being positioned in each of said doping zones, the concentration of said doping material being different in each doping zone.

For example, said plurality of doping zones includes two doping zones.

According to this embodiment, since the concentrations in doping materials are distinct in the core, the symmetry of the core is broken. This embodiment has the advantage of allowing the increase of the core birefringence, although only one type of doping material is used.

According to another embodiment of the invention, said core includes a plurality of doping materials, each doping materials of said plurality doping materials being positioned in a respective doping zone of said plurality of doping zones.

Then, the arrangement of the various doping zones including each a different doping material makes it possible to break the core symmetry. As previously mentioned, the birefringence effect is then improved.

According to the invention, said optical fiber may include a plurality of cores, each of the cores of said plurality of cores having a space symmetry, each of the cores of the plurality of cores including at least one doping material so arranged as to break the space symmetry.

This embodiment makes it possible to increase the birefringence of the optical fiber while enabling the generation of various different spectra according to the opto-geometric characteristics of each core. This also makes it possible to provide wave guides coupled by making the coherent sum of several spectra. Each wavelength injected in each core may generate the broad spectrum through a non linear effect independently of the other wavelengths. This makes it possible to obtain a spectrum having different characteristics for each core at the output of the fiber.

According to one embodiment of the invention, said at least one doping material is a rare-earth ion. This makes it possible to amplify in parallel one or several wavelengths.

This also makes it possible to obtain an inversion of population at various wavelengths to generate a laser effect or a multiple amplification.

The applicant showed that the birefringence was particularly improved when said core is a silica core surrounded with four small diameter air channels and two large diameter air channels being distributed in pairs on either side of the large diameter air channels and more particularly when the small diameter is 2.2 micrometers and the large diameter is 4 micrometers.

The invention also relates to a method for manufacturing a doped optical fiber including steps consisting in:
supplying a micro-structured optical fiber having a core with a shape space symmetry;
determining at least one symmetry axis of said shape space symmetry;
distributing at least one doping material in said core according to a dissymmetrical implantation relative to said at least one symmetry axis.

Now, an embodiment of the invention will be described while referring to the appended figures wherein:

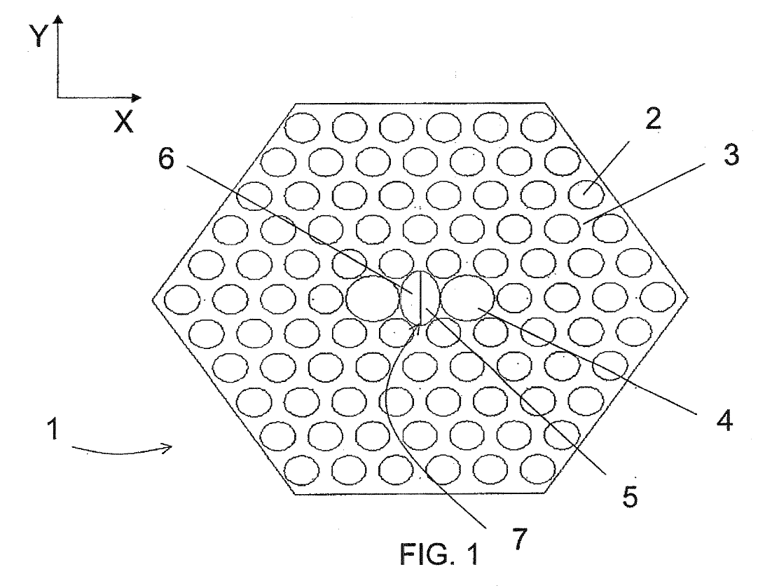

FIG. 1 is a cross-section of an optical fiber according to the invention along an XY plane;

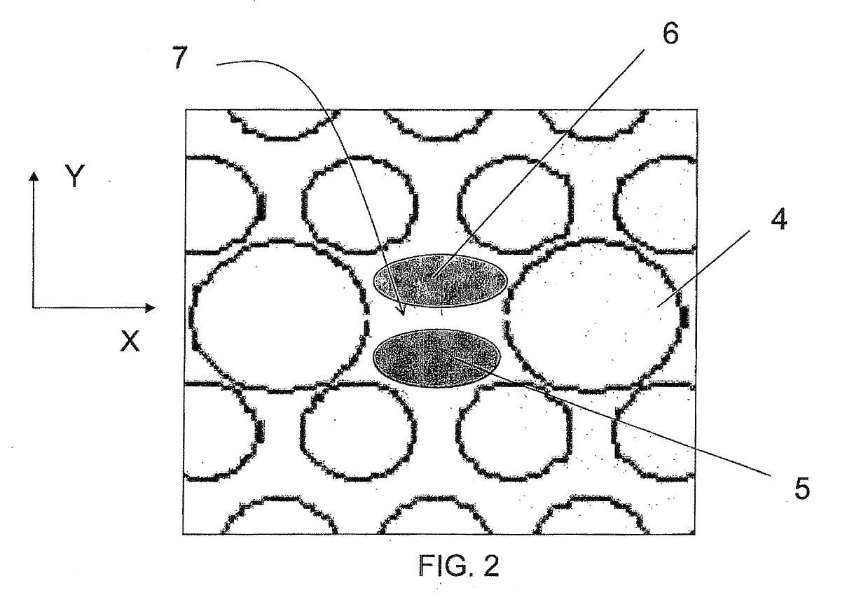

FIG. 2 is a section with an optical fiber according to a first embodiment of the invention;

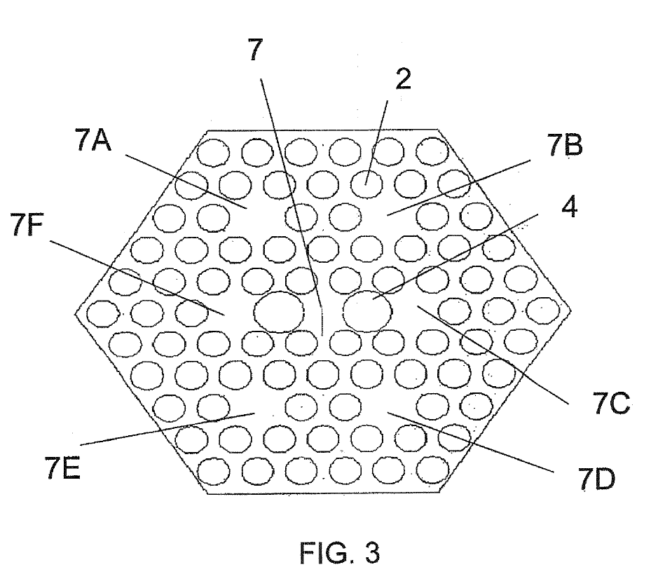

FIG. 3 is a section of a multi-core optical fiber according to the invention;

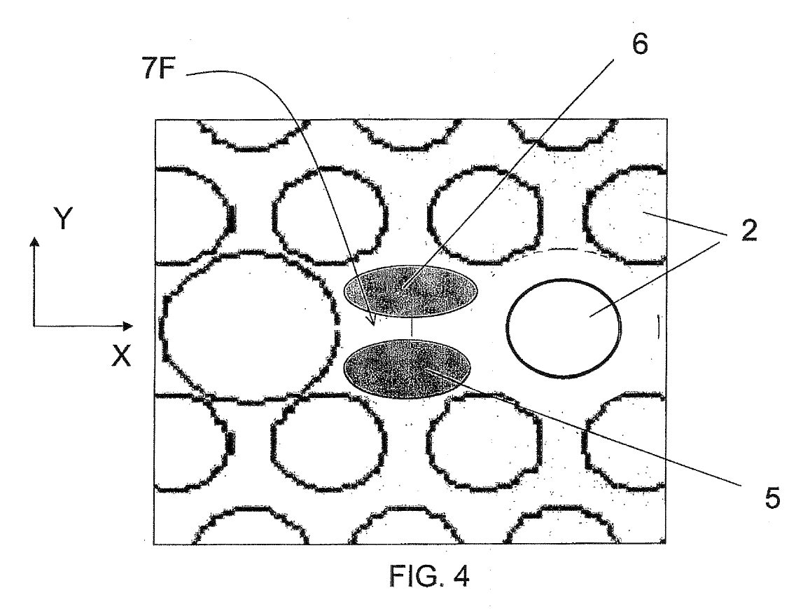

FIG. 4 is a detailed view of a core of an optical fiber according to the invention.

FIG. 1 is a cross-section of an optical fiber 1 according to the invention. The optical fiber 1 is a micro-structured fiber including a network of air channels 2 surrounding intermediate silica zones 3. This assembly of air channels 2 and silica zones 3 makes a sheath 2, 3 surrounding a core of the fiber 7.

This optical fiber 1 is, for example, manufactured using the method known as “stack and draw”, wherein the silica tubes are positioned parallel to each other.

The diameter of the air channels 2 is approximately 2.2 micrometers and the various air channels are spaced by silica zones of approximately 2.7 micrometers.

The core 7 of the fiber 1 is delimited in a non symmetric way along the X axis and the Y axis of the coordinates system illustrated in FIG. 1. In the X direction, the core 7 is delimited by two channels 4 having diameters greater than the diameters of the channels of the microstructure 2. The diameter of the channels 4 along the X axis of the core 7 is approximately 4 micrometers. In the Y direction, the core is delimited by channels having the same diameter as the channels 2 in the sheath 2, 3. Because of the presence of large diameter air channels 4, the core 7 thus has a substantially ellipsoidal shape. The core surface 7 is approximately 5 square micrometers.

The arrangement of the air channels delimiting the core 7 thus gives a space symmetry to the core 7 along both X and Y axes. In space, this corresponds to two symmetry planes.

The quantity of air in the sheath 2, 3 is approximately 65%.

The core 7 of the fiber 1 has dimensions making it possible to guide six transverse modes of a wave, corresponding to the fundamental LP01 with a polarization along X, the fundamental mode LP01 with a polarization along Y, a first higher order mode LP11 with a central zero in the X or Y directions and a polarization along X or Y. The dispersion zero wavelength is about 770 nanometers for the LP01 mode along X and Y and approximately 560 nanometers for the LP11 modes.

According to the invention, the core 7 is micro-structured in a non symmetrical way and includes two distinct doping zones 5 and 6.

The doping zone 5 and 6 includes two different materials having different refraction indexes. The core 7 is thus vertically divided into two zones 5 and 6. This division can also be vertical.

According to one embodiment, these two doping zones 5 and 6 are doped with a different doping material for each doping zone. According to the desired properties, the doping materials can be germanium, phosphorus or rare earth ions. Germanium and phosphorus may be introduced into the fiber in a larger amount than the rare earth ions and then make it possible to obtain a higher birefringence.

According to one embodiment illustrated in FIG. 2, in the core 7, the two doping zones 5 and 6 include the same doping material, for example, germanium. The concentrations of germanium are distinct in the zones 5 and 6. Zone 5 has a low doping of 3% whereas the other zone 6 has a higher doping of the order of 10%, for example.

Because of the presence of a doping material in two different concentrations on either side of the X axis in the core 7, the symmetry of the core is broken in the direction of the Y axis. Thus, the birefringence of the optical fiber 1 increases.

According to the invention, the fiber 1 may include a plurality of cores 7, 7A, 7B, 7C, 7D, 7E, 7F as illustrated in FIG. 3. The cores 7A, 7B, 7D and 7E are substantially circular since they are surrounded with air channels 2 having the same diameter. Because of the presence along the X axis of the large diameter air channels 4, the core 7 is substantially of an ellipsoidal shape as mentioned above and the air channels 7F and 7C are asymmetrical along the X axis and symmetrical relative to the X axis.

According to the invention, in each of said cores, doping zones arranged to break a space symmetry of the core are doped.

These various cores can be coupled so as to break a propagation symmetry and thus increase the birefringence effects.

As illustrated for example in FIG. 4, for the cores 7F and 7C which have a symmetry along the Y axis, two doping zones 5 and 6 are positioned on either side of the X axis separating the core 7F, either with identical doping materials in different concentrations, or different doping materials. Thus, the space symmetry of the core 7F is broken, which increases the fiber birefringence for a light flux propagating in the core 7F.

Generally speaking according to the invention, in order to improve the birefringence of an optical fiber, at least a space symmetry of the core of the fiber is determined and this core is doped so as to break the space symmetry because of the distribution of the doping material in the core.

1. A micro-structured optical fibre (1) including at least one core (7, 7A, 7B, 7C, 7D, 7E, 7F) with a shape space symmetry including at least one symmetry axis, characterised in that said core includes at least one doping material distributed in said core according to the dissymmetrical implantation relative to said at least one symmetry axis.

2. An optical fibre according to claim 1, wherein said at least one doping material is positioned in a plurality of doping zones (5, 6) of said core, each of said doping zones being distinct.

3. An optical fibre according to claim 2, wherein said core includes only one doping material, said doping material being positioned in each of said doping zones, the concentration of said doping material being different in each doping zones.

4. An optical fibre according to one of claim 1 or 2, wherein said core includes a plurality of distinct doping materials, each of the doping materials of said plurality of doping materials being located in a distinct doping zone of said plurality of doping zones.

5. An optical fibre according to claim 3, wherein said core is symmetrical relative to a symmetry axis, and wherein said core includes two doping zones, said doping zones being positioned on either side of said symmetry axis.

6. An optical fibre according to claim 1 or 2, including a plurality of cores, each core of said plurality of cores having respectively a space symmetry along at least one symmetry axis, each of the cores of the plurality of cores respectively including at least one doping material distributed in said corresponding core according to the dissymmetrical implantation relative to said at least one respective symmetry axis.

7. An optical fibre according to claim 1 or 2, wherein said doping material is selected in the group composed of a rare earth ion, germanium and phosphorus.

8. An optical fibre according to claim 1 or 2, wherein said core is a silica core surrounded with four small diameter air channels (2) and two large diameter air channels (4), the four small diameter air channels being distributed in pairs on either side of the large diameter air channels.

9. An optical fibre according to claim 8, wherein the small diameter is 2.2 micrometers and the large diameter is 4 micrometers.

10. An optical fibre according to claim 1 or 2, wherein said space symmetry is a symmetry plane.

11. A method for manufacturing a doped optical fibre including steps consisting in:
applying a micro-structured optical fibre having a shape space symmetry core;
determine at least one symmetry axis of said shape space symmetry;
distributing at least one doping material in said core according to a dissymmetrical implantation relative to said axis one symmetry axis.
